(19) United States
(12) Patent Application Publication
(10) Pub. No.: US 2012/0261351 A1
(43) Pub. Date: Oct. 18, 2012

(54) SYSTEM AND METHOD FOR TREATING WASTE

(76) Inventor: Dominic O Rathallaigh, Ballyhaunis (IE)

(21) Appl. No.: 13/086,372

(22) Filed: Apr. 13, 2011

(51) Int. Cl. C02F 11/12; C02F 1/54; C02F 1/52

(52) U.S. Cl. 210/711; 210/710; 210/205; 210/729; 210/732; 210/738

(57) ABSTRACT

A system and method for removing water from sludge including mixing a blending material into the sludge and compressing the mixture. Additional pre and post compression steps are disclosed. Examples of specific blending materials and methods for their use are disclosed.

### TECHNICAL FIELD

The present disclosure relates generally to methods and systems for treating waste. In particular, the present disclosure relates to a system and method for de-watering sludge.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a schematic drawing of one embodiment of a waste treatment system;

FIG. 2 is a cross-sectional view of a sample compression apparatus of FIG. 1; and

FIG. 3 is a flow diagram of an embodiment of the system.

### DETAILED DESCRIPTION

It will be readily understood that the components and steps of the embodiments as generally described and illustrated in the figures herein could be arranged, performed, or designed in a wide variety of different configurations. Thus, the following more detailed description of various embodiments, as represented in the figures, is not intended to limit the scope of the disclosure, but is merely representative of various embodiments. While the various aspects of the embodiments are presented in drawings, the drawings are not necessarily drawn to scale unless specifically indicated.

The phrases “connected to,” “coupled to,” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

As used herein, sludge has its common ordinary meaning. That is, sludge refers to any solid, semi-solid, or liquid waste material or precipitate. Sludge may be, but is not necessarily, generated in the treatment of wastewater. In many instances, the water content of sludge is substantial. One example of sludge is the output from a municipal water treatment plant. Municipal water treatment sludge may consist of solid matter fully or partially mixed with, or dissolved in, water. Another example may be sludge consisting of water and animal waste. Other examples of sludge may include output sludge from chemical processing, pharmaceutical processing, semiconductor processing, food processing, biomaterial processing, aluminum or ferric processing, other industrial processes, petro-chemical processing, electronic pulp and paper processing, textile processing, biomass processing, biogas processing, sludge produced in connection with power generation, and peat processing. Still further examples of sludge may include mining sludge, peat harvesting sludge, oil sludge, water purification sludge, animal slurry sludge, fruit waste sludge, fresh peat sludge, milled peat sludge, pulp and paper sludge, de-inking sludge, paper fibers sludge, food and beverage sludge, incineration generated sludge, algae sludge (including residue from biofuel production, sludge from other biofuel production methods, and recycled diaper waste sludge.

De-watering refers to processes designed at removing water from sludge. Many raw sludges are composed of as much as 98% moisture by weight. In practically all municipal wastewater treatment plants, waste water is separated into treated water and waste material. Before transporting die waste material from one location to another for further processing, it is advantageous to remove as much moisture or liquid from the sludge as possible, as this reduces the weight of the sludge. Also, the lower the percentage of moisture or liquid in the sludge, the lesser the chance of groundwater contamination due to seepage from the sludge.

De-watering may be accomplished by a variety of means, including mixing coagulants and flocculants with the sludge and compressing the mixture. Such methods are generally only partially effective, that is, such techniques may only reduce the moisture content of the sludge to 75-85% moisture by weight. Attempts to further compress the treated sludge are generally ineffective, with the sludge tending to behave like a hydraulic fluid (binding and oozing) rather than the further compression removing additional water. Settling or drying techniques may also be employed to de-water sludge. It will be appreciated that “de-watering” is not limited to removing pure water (H₂O) from the sludge. Rather de-water involves the separation and removal of the liquid components of the waste, which may be composed of water as well as other material suspended in, dissolved in, or mixed with the water and/or other liquids.

As disclosed herein, there is provided a system and method of removing water from sludge. The method comprises adding to the sludge a blending material having a porous structure in a weight ratio of relatively wet sludge to relatively dry blending material of about from 2:1 to about 10:1 depending on factors such as the type of waste and the moisture content of the waste. The blending material may include various materials and, in some embodiments, may include a compressible material. Use of a blending material in conjunction with compression may result in a large amount of moisture being removed from the sludge, in some instances resulting in a moisture content of less than 20%. By comparison, de-watering by coagulating or flocculating and compression generally results in a moisture content of around 75%-85%.

Suitable blending materials can vary and in one embodiment may include cellulose-based materials, for example wood shavings, newsprint and milled peat. In addition, trommel fines, for example, the particles collected via trommel screens during the recycling of household waste, can also be employed as a blending material. The blending material may comprise wood dust such as that generated by the machining of Medium Density Fiberboard (MDF), chipboard, particle board, oriented strand board and the like. Wood dust may comprise a compressible material, such as a resilient binding material, such as glue, resin such as urea-formaldehyde, and the like. The compressible material includes a crystalline spacer-like structure-adapted to substantially-maintain at-least-some or most of its structure during compression, to allow the water to be escape. Other dry wood dust may be used as well.

Additional blending materials can be used, such as wheat, barley, oats, rice and straw. By pulverizing and impregnating or treating these blending materials, good dewatering results can occur. In a preferred embodiment, these additional blending materials can be used if first processed by a Hammermill or similar device, in order to produce a produce a powder or coarse material, adapted for-mixing with a sludge cake, for improved dewatering.

In another embodiment the blending material comprises suitably sized plastic material. The plastic materials may be synthetic, semi-synthetic, or polymers. The plastic materials may include elastic hydrocarbons such as natural and synthetic rubber, bioplastics, biodegradable plastics, acrylics, polyesters, silicones, polyurethanes, halogenated plastics, and the like. The plastic materials may include a thermoplastic polymer such as polyethylene, polypropylene and the like. The plastic materials may be generated through recycling and milled to the appropriate size and shape as disclosed below.

The blending material may comprise metal or metal alloy materials, collectively referred to herein as metallic materials, such as iron, aluminum, and the like. The metallic materials may be initially generated as a byproduct of machine work such as metal shavings. The metallic materials may then be processed in a suitable size and shape.

The blending material may also comprise natural sand including rock and mineral particles such as silica.

Those of skill in the art will appreciate that this list is not exhaustive of all possible blending materials. A variety of blending materials can be used without departing from the present disclosure. Therefore, without limiting the types of blending materials to those listed, specific embodiments utilizing specific blending materials are further described below. Further, the specific disclosure below is intended to supplement, not limit, the disclosure provided throughout. Thus, while specific combinations and ratios of blending materials are described below, each blending material may be used alone or in any combination with any other blending material in any ratio of sludge to blending material without departing from the scope and spirit of the present disclosure.

Blending materials may be conditioned or pre-conditioned in a certain manner to enhance the ability to expel water. For example, blending materials may be milled to a very fine consistency, such as at a size of about 500μ or less. Thus, the pre-conditioned blending materials will have a consistency akin to sander dust or flour. As can be appreciated, it is customary practice to measure particles in one dimension (μm, mm, etc.) with the understanding that such particles are three dimensional. For purposes of disclosure herein, particle sizes are disclosed in the metric length as this is a suitable and commonly used substitute to describe “particle size.” Typically, reference to a single dimension is used when buying certain particle sizes as classified particles on the market (determination by commonly accepted industry standard) and/or as measured by a classifying sieve (determination by measuring method).

With a fine consistency, the pre-conditioned blending materials presents a large surface area and during a predetermined short vigorous mixing, will substantially evenly disperse throughout the wet material. In one embodiment, the blending materials that provide good results are finely milled rice-husks, finely milled nut shell, finely milled com cob, finely milled palm frans, finely milled bamboo, finely milled strand board, finely milled wood, finely milled polyethylene or polypropylene powder, finely milled iron, and finely milled sand. In one embodiment, the polyethylene powder comprises Borealis rm8343, obtainable from Borealis. One blending material comprises milled polyethylene and/or polypropylene powder, because it can be easily separated and reused a number of times.

Various conditioned or pre-conditioned blending materials require different ratios to obtain the desired dewatering effect. For example, in one embodiment, when using milled strand board, a sludge cake to blending material weight ratio of about 10:1 has been found to be most effective, depending on the moisture levels of the material to be dewatered. This holds true for many of the blending materials. In one embodiment, when a polyethylene powder is utilized as a blending material, a sludge cake to blending material weight ratio of about 1:1 has been found to be most effective. Generally, about 50 to 80 percent of the moisture in these materials to be dewatered, can be removed in this process.

In one embodiment, the blending material comprises a compressible material of about 25% or less by weight of the blending material for improved dewatering during compression, and preferably about 10% to about 20% by weight of the blending material, for improved dewatering during compression. The compressible material provides a crystalline spacer-like structure adapted to substantially maintain its structure during compression, to allow the water to be escape. It is believed that, during initial compression the spacer-like structure allows an escape path, defining a first stage, and after the first stage, the spacer-like structure can slightly deform to allow additional water to escape, defining a second stage. In more detail, the crystalline spacer-like structure in the first stage has a first diameter that allows water to escape. In the second stage, the crystalline spacer-like structure has a second diameter, which is less than the first diameter, to allow further water to escape.

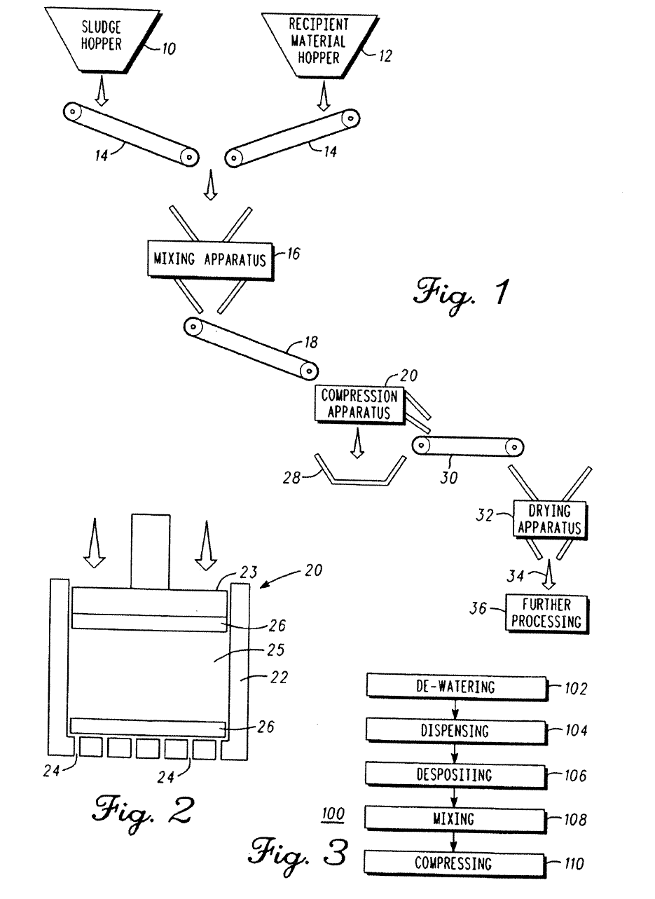

Referring to FIG. 1, a waste treatment system according to one embodiment is shown. Sludge, as output from a wastewater treatment plant or other suitable producer of wastewater material, is initially de-watered into a semi-solid sludge cake. The sludge cake is collected in a sludge hopper 10. A suitable blending material to be mixed with the sludge cake is collected in a hopper 12.

As shown in FIG. 1, the sludge cake and the blending material are dispensed from their respective hoppers 10, 12 to separate conveyors 14. The sludge cake and the blending material are deposited into a suitable mixing apparatus 16. It will be understood by those skilled in the art, that the mixing apparatus 16 may be chosen from at least one of a paddle mixer, screw mixer, agri feed mixer and any mixing or blending device, as known in the art.

The mixing apparatus 16 blends the sludge cake and the blending material together to create a composite mixture. The mixing apparatus is operable to mix the sludge cake and the blending material together, preferably at a slow rate, such that the mixture is folded together rather than beaten, for improved mixing for example.

In one embodiment, the mixing process is performed by folding successive layers of sludge cake into contact with layers of the blending material. Further mixing may be accomplished through the continued folding together of layers of the composite mixture, until the concentration of the composite mixture is substantially evenly spread.

The ratio of blending material to sludge cake in the composite mixture may be adjusted depending on the type of blending material used. For example, when using wood shavings, a sludge cake to blending material weight ratio of about 10:1 has been found to be most effective, while in the case of milled peat the preferred ratio is about 2.5:1. In the case of MDF dust material, one ratio of sludge cake to dust ranges from about 5:1 to about 2.5:1, depending on the dry matter content of the sludge cake.

As shown in FIG. 1, the composite mixture exits the mixing apparatus 16 onto a conveyor 18. The composite mixture is then delivered to a compression apparatus 20. The compression apparatus 20 may be chosen from anyone of a belt press, a screw press, a plate press, a batch press, a filter press, a hydraulic press, or any compression device as known in the art. The compression apparatus 20 is configured to allow the release of moisture from the contained mixture during compression.

For example, the compression apparatus 20 may comprise a plate press having a conveyor located within the compression apparatus to firstly convey the composite mixture into the compression apparatus, and to secondly convey the composite mixture after compression out of the compression apparatus for further processing. The conveyor can be configured to allow the release of moisture from the contained mixture during compression. For example, in the case of a standard belt conveyor, the belt can be perforated to allow the moisture to drain through the conveyor belt. One or more of the plates used in the plate press can also be perforated, to allow the escape of moisture during compression.

As shown in FIG. 2, a cross-section of a sample compression apparatus 20 is depicted. An enclosed plate press 22 comprising a compression ram 23 and an interior chamber 25, is shown. The compression apparatus 20 is provided with a series of apertures 24 to allow the drainage of moisture from the device 20. In FIG. 2 of the plate press 22, the apertures 24 are provided in the surface of the plate press 22 that the compression ram 23 acts against. Initially, the ram 23 is maintained in an ‘at rest’ position at that side of the plate press 22 opposite to the apertures 24, for example, the top of the plate press 22. In order to prevent the composite mixture itself from being squeezed through the apertures during compression, a filter material 26 is provided over the apertures 24 and over the surface of the ram 23 acting on the composite mixture. The filter material 26 can be made from any porous material that allows through passage of liquids and minimizes the flow of solids, for example, such as cotton.

In operation, the composite mixture is supplied to the interior chamber 25 of the plate press 22. During compression, the ram 23 is driven in a downwards direction, towards the apertures 24. As the composite material is compressed, moisture is forced from the mixture, in the form of wastewater. The expelled wastewater then passes through the filter material 26, and exits the plate press through the apertures 24. Referring back to FIG. 1, the wastewater is then collected in a suitable drain 28.

It will be understood that the above configuration for the plate press may be adapted as required for the other types of compression apparatus as mentioned, i.e. that the compression apparatus are configured to allow the escape of wastewater during compression, while retaining the solid material.

The compression generally occurs at pressures between 1379 kPa (200 psi) and 13789 kPa (2000 psi). A large amount of wastewater is expelled from the mixture at lower pressures, but if compression is maintained at these levels, the majority of wastewater is substantially eliminated from the mixture. The pressure may be applied gradually, and is maintained for a period of time to ensure maximum de-watering of the composite mixture. For example, for a portion of composite mixture having a width of approximately 101.6 cm (40 inches) and a depth of approximately 101.6 cm (40 inches), the period of time for compression to substantially ensure maximum dewatering should be at least 30 seconds. The wastewater expelled from the composite mixture can then be returned to the wastewater treatment plant for further processing and refinement.

The presence of the blending material in the composite mixture allows for a greater proportion of moisture to be squeezed from the sludge cake. Expelling the moisture from the composite mixture produces a substantially de-watered resultant material, with a dry solids content of upwards of 20%.

The resultant material is removed from the compression device 20 and brought by conveyor 30 to drying apparatus 32. The substantially de-watered resultant material is more easily dried due to the reduced levels of moisture present. The drying apparatus 32 can be one of a cyclonic dryer, a thermal dryer, an air dryer, a drum dryer, or any drying device as known in the art, for example, the Tempest Drying System manufactured by GRRO Incorporated is one such device. Drying can be accomplished through an apparatus that uses waste heat or low grade heat to reduce expense. Drying may also be accomplished through natural drying, mechanical drying, and drying with heat.

After drying, the resultant material is substantially solid. The solid material exits the drying apparatus at 34 and can then be further processed (system or apparatus) 36, depending on the application. For example, the further processing 36 can be pelletiser, to convert the solid material into pellets for burning as fuel.

It will be understood that the resultant material can also be utilised as a substitute for the blending material to be mixed with the sludge cake. It has been found that the resultant material produced by the process may be re-used as blending material for approximately three iterations, before the de-watering effects start to decline.

As discussed further below, an additional processing step may include separating the blending material and the sludge cake material to thereby enable reuse of the blending material. The separated blending material operates as a superior blending material than the resultant material.

In an alternate embodiment, the mixing and compression steps can be performed on location at a waste treatment plant, with the drying (and possibly palletising) steps performed at a remote location. In this case, the drying apparatus 32 in FIG. 1 may be replaced by a truck or suitable transport device that transfers the resultant material output from the compression apparatus 20 to a centralised location where the drying and palletising stages are carried out.

Alternatively, the waste treatment apparatus itself may be provided as part of a mobile waste collection system. In this case, the hoppers 10,12, mixing apparatus 16, and compression apparatus 20 are provided as part of a vehicle, for example on the rear of a truck, or on a truck trailer. The drying apparatus 32 may optionally be provided as part of the vehicle or, as above, the drying and further processing stages of the method may be performed at a remote location. An advantage of this mobile system is that businesses, for example farmers, that may not be able to afford construction of the system or would not be in a position to continually utilise the system, could be visited by the mobile apparatus, such as by a waste service provider, for the treatment of their waste.

Use of this process or system, can result in a reduced moisture-level end product, with more manageable properties and a dry solids content approaching upwards of 50-70%. The end material is substantially reduced in weight as opposed to conventional moisture extraction techniques, and is more easily transportable.

As shown in FIG. 3, a system for removing water from sludge 100, is shown. In one form, the system 100 includes: de-watering 102 sludge comprising an output from a wastewater treatment system to form a semi-solid sludge cake; dispensing 104 the sludge in a sludge hopper and dispensing a blending material in a recipient blending material hopper; depositing 106 the sludge and the blending material in a mixing device; mixing 108 the sludge and the blending material having a porous structure in a weight ratio of the sludge to the blending material of about from 2:1 to about 10:1; and compressing 110 the sludge and the blending material to release moisture.

The system 100 provides an improved method of de-watering sludge, for more efficient processing, transporting and recycling, depending on the application. The system 100 can dewater sludge cake from a wastewater stream, for example, and further dewater the sludge cake, which can then be recycled, reused or disposed of. This system can be environmentally friendly, by providing recycling and/or producing less material needing disposal, for example.

In one embodiment, the system 100 can improve dewatering of sewage sludge, both in undigested or undigested applications, and in one embodiment, in a digested application, for example, the sludge is pre-processed in a container where anaerobic digestion and processing occurs.

The system 100 has a wide variety of potential applications. For example, the system can be used in sludges in connection with the processing of: human, animal and the like waste; aluminium, ferrics and the like; pharmaceutical products; chemical products; semiconductor products; drugs and foods, such as in meat and milk processing, and the like.

In the event the feed stock blending material does not include a compressible material, a compressible material can be added to and mixed in the blending material. For example, in FIG. 1, a sludge hopper 10, material hopper 12 and an additional hopper for the compressible material (not shown in FIG. 1), can be fed via lines 14 and mixed in mixing apparatus 16. This can substantially improve dewatering during compression, as compared to the absence of the compressible material. As would be understood by those skilled in the art, other ways can be implemented, for mixing these three constituents.

In one embodiment, the mixing step 108 includes folding successive layers of sludge cake with the blending material and forming a composite mixture, such that the sludge and blending material are substantially evenly spread, for improved de-moisturization.

In one embodiment, the mixing step 108 can include substantially homogenous mixing, to provide improved dewatering, provided the correct ratios are maintained. Rapid or slow mixing can be used. In an embodiment, the mix may be of a texture being substantially evenly mixed throughout. Over mixing can disadvantageously result in a pasty-like material that is not adapted for dewatering in this process. Depending on the moisture content of the sludge cake, the amount of blending material for use in connection with this system can vary. For example, in one embodiment, the amount of blending material can be about 5% by weight to about 60% by weight, for providing the desired consistency of the mix.

Also, in an embodiment, relative to the mixing step 108, the weight ratio of the sludge cake to blending material is about 10:1 when the blending material comprises wood shavings, the weight ratio of the sludge cake to blending material is about 2.5:1 when the blending material comprises milled peat, and the weight ratio of the sludge cake to blending material is about 5:1 to about 2.5:1 when the blending material comprises a cellulose-based material treated with a urea formaldehyde resin, for improved de-watering of sludge.

The compressing step can vary. In one embodiment, mix is placed or poured in a compressive device and subjected to a certain pressure for desired dewatering. The mixed can be placed on a porous belt, such as a polyester, polyamide or cloth belt, with an air permeability of about 360 cubic feet/minute (CFM) at a pressure of 125 PA. In more detail, the belt can be placed or positioned on a porous rigid plate that is raised. The plate may have 5 mm holes at 15 mm centers, spaced throughout. The mixed can be subjected to pressure by means of a push plate. The mix can be compressed or squeezed, and the moisture and water is expelled through the porous belt and holes. The amount of pressure required to expel the water varies.

The system 100 can further include at least one of drying the compressed, resultant material in the compressing step 110, and converting it to form a solid material adapted for use as fuel, re-use as a blending material and the like.

In one embodiment, the system 100 can include further processing, such as macerating and/or pulverizing the compressed, resultant material. Thus, after the material has been compressed, it is removed from a compression chamber and can be macerated vigorously. The maceration step seeks to break up and separate the blending material or dust particles comprising smaller particles, from the larger dewatered sludge cake particles. Maceration may be done with various machines such as a hammer mill, high speed mixer with chopping knives or similar device to substantially pulverize the material into a powder consistency.

After compression, another possible processing step is to separate the compressed, resultant material into the blending material and dewatered sludge cake. Reclamation of the blending material is advantageous if there is a sufficiently high recovery rate. Thus, if the blending material can be efficiently isolated, it can be reused for subsequent dewatering processes.

The blending material may, during the compression, drying, and separation processes become altered from its original state. The blending material may change its appearance or have one or more of its characteristics or properties altered. For example, the blending material may be deformed, swelled, change temperature, change the particle sharpness, form crumbles, be broken up, and the like. Furthermore, separated blending material may also include an amount of the dewatered sludge cake. As used herein, the term blending material generally applies to blending material in an original state and blending material that has been mixed, compressed, and separated for reuse.

Prior to separation, the compressed, resultant material is dried to reduce adhesion between the blending material and the dewatered sludge cake. The drying step enables separation of the blending material at an acceptable recovery rate. Otherwise, the reclamation efficiency does not merit the resource expense of separation. Thus, the drying process must be sufficient to provide for a high recovery rate of blending material. The higher the recovery rate, the lower the cost of replenishment of blending material and the associated logistical cost.

Drying may be accomplished through natural means or through any number of mechanical devices such as a cyclonic dryer, a thermal dryer, an air dryer, a drum dryer, or any drying device as known in the art. An additional drying technique may include use of a pulverizing apparatus as disclosed in U.S. Pat. No. 6,722,594 entitled Pulveriser and Method of Pulverising. As disclosed, materials subjected to the pulverizing are also dried in the process. After the drying step, the compressed, resultant material is ready to be separated.

Separation may be performed in various ways since the particles of the dewatered sludge cake and blending material have different sizes and weights. For example, a vibratory screen, air separator, a gravity separator, cyclonic separator, centrifuge or sieving device may be used to separate the majority of the finely milled blending material from the sludge cake material. After separation, the blending material can be reclaimed for reuse and the dewatered sludge cake can be disposed, recycled, etc. In the case of the polyethylene and polypropylene powder, separation may be achieved through electrostatic charge. In the case of metallic powder, separation may be achieved through magnetic devices. Although complete separation cannot be efficiently achieved, the blending material may nevertheless be substantially separated for reuse.

In one embodiment and in more detail, a system for removing water from sludge is shown and disclosed herein. It can include: depositing a semi-solid sludge cake and a blending material in a mixing device; mixing the sludge and the blending material having a porous structure in a weight ratio of the sludge to the blending material of about from 1:1; compressing the sludge and the blending material to release moisture; drying the resultant material; and separating the blending material from the sludge cake. Improved dewatering can be gained by following this system, as detailed herein.

The semi-solid sludge cake can comprise at least one of: sludge in connection with the processing of peat harvesting, human waste, animal waste, aluminium, ferrics, pharmaceutical products, chemical products, semiconductor products, drugs and foods, sewage sludge, oil sludge, water purification sludge, animal slurry sludge, fruit waste sludge, fresh peat sludge, milled peat sludge, paper sludge, de-inking sludge, paper fibers sludge and recycled diaper waste sludge. Thus, the system has a multiplicity of applications.

In another embodiment, also as shown in FIG. 3, an improved waste treatment method for removing water from sludge is shown and disclosed. It includes the steps of: de-watering 102 the sludge comprising an output from a wastewater treatment system to form a semi-solid sludge cake; dispensing 104 the semi-solid sludge cake in a hopper and dispensing a blending material in a recipient blending material hopper; depositing 106 the semi-solid sludge cake and the blending material in a mixing device; mixing 108 the semi-solid sludge cake and the blending material having a porous structure in a weight ratio of the semisolid sludge cake to the blending material of about from 1:1; compressing 110 the semi-solid sludge cake and the blending material to release moisture; drying the resultant material to minimize adhesion; separating the blending material from the sludge cake; and reusing the blending material.

The system 100 provides an improved method of de-watering sludge, for more efficient processing, transporting and recycling, depending on the application. Further, the system 100 can dewater sludge cake from a wastewater stream, for example, and further dewater the sludge cake, which can then be recycled, reused or disposed of. This system can be environmentally friendly, by providing recycling and/or producing less material needing disposal, for example.

In one arrangement, the blending material is a compressible material, such as a crystalline spacer-like structure adapted to substantially maintain at least some or most of its structure during compression, to allow the water to be escape, as detailed previously.

In one embodiment, the mixing step 108 includes forming a composite mixture, such that the semi-solid sludge cake and the blending material are substantially evenly dispersed, for improved de-moisturization during compression, as detailed earlier.

In yet another embodiment, the improved waste treatment method for removing water from sludge comprises the steps of: de-watering 102 the sludge comprising an output from a wastewater treatment system to form a semi-solid sludge cake; dispensing 104 the semi-solid sludge cake in a hopper and dispensing a blending material in a recipient blending material hopper; depositing 106 the semi-solid sludge cake and the blending material in a mixing device; mixing 108 the semi-solid sludge cake and the blending material having a porous structure in at least one of: a weight ratio of the semi-solid sludge cake to the blending material of about from 1:1 when the blending material comprises a thermal polymer such as polyethylene powder; and a weight ratio of the semi-solid sludge cake to the blending material of about from 10:1 when the blending material comprises at least one of: milled rice husks, milled nut shell, milled corn cob, milled palm frans, milled bamboo, milled strand board, milled wood and a milled strand board; compressing 110 the semi-solid sludge cake and the blending material to release moisture forming a compressed, resultant material; drying the compressed, resultant material to reduce adhesion; separating the blending material from the sludge cake; and reusing the blending material.

A system to perform the functions disclosed herein includes a mixing apparatus configured to mix sludge with a blending material to form a mixture and a compression apparatus, as disclosed above, that is configured to compress the mixture of sludge and the blending material to remove water and create the compressed material. The system may also include a drying apparatus configured to dry the compressed material and a separator configured to substantially separate the blending material and the sludge. The mixing apparatus, compression apparatus, drying apparatus and separator may be physically coupled to one another to form an integrated unit. Alternatively, one or more of the disclosed apparatuses may be physically separated from one another. Indeed, each apparatus may be separate from one another. In one embodiment, the system may include one or more conveyance devices to deliver material from one apparatus to another.

In one embodiment, the method includes conditioning the blending material to form a fine consistency before the dispensing step; macerating the compressed, resultant material after the compressing step; drying the compressed, resultant material; and separating the semi-solid sludge cake and the blending material making up the compressed material, for improved efficiencies and results. The separated semi-solid sludge cake may be converted to a solid material adapted for use as fuel and the blending material is adapted for reuse.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

1. A method for removing water from sludge, comprising:
mixing the sludge and at least one blending material;
compressing the mixture of sludge and blending material to release water and create a resultant material;
drying the resultant material to reduce adhesion between the sludge and the blending material; and
substantially separating the sludge and the blending material.

2. The method of claim 1, further comprising mixing the substantially separated blending material with a second sludge.

3. The method of claim 1 wherein the weight ratio of the sludge to the blending material is about 1:1 to about 10:1.

4. The method of claim 1, wherein mixing the sludge and the at least one blending material comprises distributing the blending material throughout the sludge in a substantially uniform manner.

5. The method of claim 1, wherein the blending material comprises a plastic.

6. The method of claim 5, wherein the blending material comprises polyethylene.

7. The method of claim 1, wherein the blending material comprises sand.

8. The method of claim 1, wherein the blending material comprises a metallic material.

9. The method of claim 1, further comprising pre-conditioning the blending material to a fine consistency.

10. The method of claim 1, wherein the pre-conditioning step includes milling
the blending material to a dimension of about 500μ or less.

11. The method of claim 1, wherein the blending material is a compressible material.

12. A system for removing water from sludge, comprising:
a mixing apparatus configured to mix sludge with a blending material to form a mixture;
a compression apparatus configured to compress the mixture of sludge and the blending material to remove water and create a compressed material;
a drying apparatus configured to dry the compressed material; and
a separator configured to substantially separate the blending material and the sludge.

13. The system of claim 12, wherein the weight ratio of the sludge to the blending material in the mixture is about 1:1 to about 10:1.

14. The system of claim 12, wherein the mixing apparatus is further configured to mix the sludge and the at least one blending material in a substantially uniform manner.

15. The system of claim 12, wherein the blending material comprises a plastic.

16. The system of claim 15, wherein the blending material comprises polyethylene.

17. The system of claim 12, wherein the blending material comprises sand.

18. The system of claim 12, wherein the blending material comprises a metallic material.

19. The system of claim 12, wherein the blending material comprises a material pre-conditioned to a fine consistency.

20. The system of claim 12, wherein the blending material includes particles having a dimension of about 500μ or less.

21. The system of claim 12, wherein the blending material is a compressible material.

22. The system of claim 12, wherein the separated blending material is suitable for mixing with a second sludge.

23. The system of claim 12, wherein the mixing apparatus is coupled to the compression apparatus.

24. The system of claim 23, wherein the drying apparatus is coupled to the compression apparatus.

25. The system of claim 24, wherein the separator is coupled to the drying apparatus.

26. A method for removing water from sludge, comprising:
providing a blending material comprising plastic particles of a predetermined size;
mixing the sludge and the blending material; and
compressing the mixture of sludge and blending material to release water and create a resultant material.

27. The method of claim 26, further comprising drying the resultant material to reduce adhesion between the sludge and the blending material; and
substantially separating the resultant material into blending material and sludge.

28. The method of claim 26, wherein the plastic particles comprise polyethylene.

29. A method for removing water from sludge, comprising:
providing a blending material comprising metallic material of a predetermined size;
mixing the sludge and the blending material; and
compressing the mixture of sludge and blending material to release water and create a resultant material.

30. The method of claim 29, further comprising drying the resultant material to reduce adhesion between the sludge and the blending material; and
substantially separating the resultant material into blending material and sludge.

31. The method of claim 29, wherein the metallic material comprises iron.
